(19) United States
(12) Patent Application Publication
(10) Pub. No.: US 2016/0014029 A1
(43) Pub. Date: Jan. 14, 2016

(54) Method and Apparatus for Congestion Signalling for MPLS Networks

(71) Applicant: TELEFONAKTIEBOLAGET L M ERICSSON (PUBL), Stockholm (SE)

(72) Inventors: Song Yuan, Beijing (CN); Jiang He, Beijing (CN)

(21) Appl. No.: 14/769,917

(22) PCT Filed: Feb. 25, 2013
(86) PCT No.: PCT/CN2013/071834

§ 371 Date: Aug. 24, 2015

(51) Int. Cl. H04L 12/801; H04L 12/723

(52) U.S. Cl. CPC H04L 47/11; H04L 45/50

(57) ABSTRACT

Methods and apparatuses for congestion signaling for MPLS networks have been disclosed. A method for use by a transit node on a LSP within an MPLS network comprises: generating a congestion notification in response to a congestion occurring during transmission of packets; and transmitting the congestion notification to an egress node on the LSP. Further, a method for use by an egress node on a LSP within an MPLS network comprises: obtaining a congestion notification, wherein the congestion occurs during transmission of packets; and handling the congestion notification. Thus, a congestion signaling mechanism in MPLS networks are introduced.

### TECHNICAL FIELD

Embodiments of the present invention generally relates to communication systems, and more particularly to methods, a transit node, an egress node, and a computer-readable storage media for congestion signaling for multi-protocol label switching (MPLS) networks.

### BACKGROUND

This section introduces aspects that may help facilitate a better understanding of the invention(s). Accordingly, the statements of this section are to be read in this light and are not to be understood as admissions about what is in the prior art or what is not in the prior art.

Nowadays, more and more telecommunication operators deploy Multi-Protocol Label Switching-Traffic Engineering (MPLS-TE) for a better user experience. Multi-Protocol Label Switching (MPLS) is a highly scalable, protocol agnostic, data-carrying mechanism that directs data from one network node to the next based on short path labels rather than long network addresses.

In MPLS networks, routers that perform routing based on the label are called label switch routers (LSRs). The ingress node and egress node of an MPLS Label-switched path (LSP) are called label edge routers (LERs), which, respectively, push an MPLS label onto an incoming packet and pop it off the outgoing packet. Label-switched paths (LSPs) are established by the network operator for a variety of purposes, such as to create network-based IP virtual private networks or to route traffic along specified paths through the network.

FIG. 1 illustrates the bandwidth reservation for a specific LSP. The upstream router (e.g., R1) sends out the Resource Reservation Protocol (RSVP) RESV (short for “Reserve”) message with Traffic-Specification (T-SPEC) object (as indicated by solid arrow in FIG. 1), which contains the bandwidth reservation requirements, to its adjacent downstream router (e.g., R2) first. If the downstream router (i.e., R2) can allocate a LSP which meets the requirements, it sends back the PATH message (as indicated by dotted arrow in FIG. 1). Similar processes may occur among other routers (e.g. between the router R2 and the router R3, and between the router R3 and the router R4). Thus, a LSP provisioned with required bandwidth can be set up in a manner of end-to-end.

Even with the blossom of transport capacity, congestions still occur quite often. Once a LSP is experiencing congestion, there is no way for it to indicate the transmitter to slow down the transmission rate.

In IETF RFC 3540, N. Spring, et. al., “Robust Explicit Congestion Notification (ECN) Signaling with Nonces”, congestion signalling/control methods in IP networking have been discussed. However, the ECN cannot be applied on the MPLS packets directly.

The congestion control in MPLS networks has been investigated for a long time. For example, in U.S. Patent publication No. 20080186852A1, a content-aware congestion control scheme for software MPLS routers has been discussed. The content-aware congestion control scheme enables the MPLS routers to discard packets with less important content when there is congestion in the network. Another reference is, “Priority-Based Congestion Control in MPLS-Based Networks,” Scott Fowler, Sherali Zeadally, Advanced Industrial Conference on Telecommunications/Service Assurance with Partial and Intermittent Resource Conference /E-Learning on Telecommunications Workshop (AICT/SAPIR/ELETE '05), 2005. However, no congestion notification mechanism is mentioned.

### SUMMARY

Therefore, it would be desirable in the art to provide a congestion signaling mechanism in MPLS networks. The introduction of congestion signaling mechanism can be backward compatible with existing facilities in the MPLS networks. It would also be desirable that the congestion signaling mechanism in the MPLS networks may incorporate with the congestion signaling or control methods in IP networks, e.g., Explicit Congestion Notification (ECN).

To better address one or more of the above concerns, in a first aspect of the invention, a method for use by a transit node on a label switched path (LSP) within a multi-protocol label switching (MPLS) network is provided. The method comprises: generating a congestion notification in response to a congestion occurring during transmission of packets; and transmitting the congestion notification to an egress node on the LSP.

In some embodiments, transmitting the congestion notification may comprise transmitting the congestion notification along the LSP to the egress node.

In some embodiments, the congestion notification is transparent to downstream transit nodes on the LSP.

In some embodiments, the congestion notification comprises a field indicating itself as a congestion notification, and a field of information about discarded packets under the congestion.

In a second aspect of the invention, a method for use by an egress node on a label switched path (LSP) within a multi-protocol label switching (MPLS) network is provided. The method comprises: obtaining a congestion notification, the congestion occurring during transmission of packets; and handling the congestion notification.

In some embodiments, handling the congestion notification may comprise at least one of the following: transmitting the congestion notification to an ingress node on the LSP; and transmitting the congestion notification to a destination node of the packets within an IP network, such that the congestion notification can be forwarded to a source node of the packets within an IP network.

In some embodiments, transmitting to the ingress node may comprise transmitting over a corresponding reverse LSP. In some embodiments, forwarding to the source node may comprise transmitting via an IP routing from the destination node to the egress node, via a corresponding reverse LSP from the egress node to the ingress node, and via an IP routing from the ingress node to the source node.

In some embodiments, obtaining a congestion notification may comprise at least one of the following: receiving the congestion notification from an upstream node on the LSP; and generating the congestion notification in response to the congestion occurring.

In a third aspect of the invention, a transit node is provided to implement various embodiments of the method of the first aspect of the invention. Specifically, a transit node on a label switched path (LSP) within a multi-protocol label switching (MPLS) network is provided. The transit node comprises: a generation unit configured to generate a congestion notification in response to a congestion occurring during transmission of packets; and a transmitting unit configured to transmit the congestion notification to an egress node on the LSP.

In some embodiments, the transit node further comprises a detection unit configured to detect the occurrence of the congestion by monitoring amount of discarded packets during a predefined period of time.

In a fourth aspect of the invention, an egress node is provided to implement various embodiments of the method of the second aspect of the invention. Specifically, an egress node on a label switched path (LSP) within a multi-protocol label switching (MPLS) network is provided. The egress node comprises: an obtaining unit configured to obtain a congestion notification, the congestion occurring during transmission of packets; and a handling unit configured to handle the congestion notification.

In a fifth aspect of the invention, an apparatus is provided, which comprises at least one processor and at least one memory including computer program code. The memory and the computer program code are configured to cause the apparatus to perform embodiments of the method of the first aspect of the invention and/or embodiments of the method of the second aspect of the invention.

In a sixth aspect of the invention, a computer-readable storage media having computer program code stored thereon is provided. The computer program code is configured to, when executed, cause an apparatus to perform embodiments of the method of the first aspect of the invention and/or embodiments of the method of the second aspect of the invention.

In a seventh aspect of the invention, an apparatus is provided, which comprises means for implementing each step of the method of the first aspect of the invention and/or each step of the method of the second aspect of the invention.

Particular embodiments of the subject matter described in this specification can be implemented so as to realize one or more of the following advantages.

With particular embodiments of the techniques described in this specification, a congestion signaling mechanism in MPLS networks are introduced. Further, by transmitting the congestion notification along the LSP and/or the reverse LSP, an in-band congestion signaling mechanism is provided, which is more simple and reliable.

Other features and advantages of the embodiments of the present invention will also be understood from the following description of specific embodiments when read in conjunction with the accompanying drawings, which illustrate, by way of example, the principles of embodiments of the present invention.

### BRIEF DESCRIPTION OF THE DRAWINGS

The above and other aspects, features, and benefits of various embodiments of the invention will become more fully apparent, by way of example, from the following detailed description and the accompanying drawings, in which:

FIG. 1 exemplarily illustrates the bandwidth reservation for a LSP;

FIG. 2 illustrates an example scenario where embodiments of the present invention may be applied;

FIG. 3 illustrates another example scenario where embodiments of the present invention may be applied;

FIG. 4 illustrates an exemplary signal flow according to embodiments of the present invention;

FIG. 5 illustrates another exemplary signal flow according to embodiments of the present invention;

FIGS. 6-7 illustrate an example mechanism for recognizing the LSP under congestion;

FIG. 8 illustrates an exemplary flowchart of a method for congestion notification transmission procedure according to embodiments of the present invention;

FIG. 9 illustrates an exemplary flowchart of a method of congestion control procedure for an egress node according to embodiments of the present invention;

FIG. 10 illustrates an exemplary congestion notification packet according to embodiments of the present invention;

FIG. 11 illustrates an exemplary signal flow for transmitting congestion notification to the downstream hosts according to embodiments of the present invention;

FIG. 12 illustrates an exemplary signal flow for transmitting congestion notification to upstream hosts according to embodiments of the present invention;

FIG. 13 illustrates an exemplary signal flow for transmitting congestion notification to upstream nodes according to some other embodiments of the present invention;

FIG. 14 is a schematic block diagram of an apparatus 1400 that may be configured to practice exemplary embodiments according to one aspect of the present invention;

FIG. 15 is a schematic block diagram of an apparatus 1500 that may be configured to practice exemplary embodiments according to another aspect of the present invention; and

FIG. 16 illustrates a simplified block diagram of an entity 1600 that is suitable for use in practicing exemplary embodiments of the present invention.

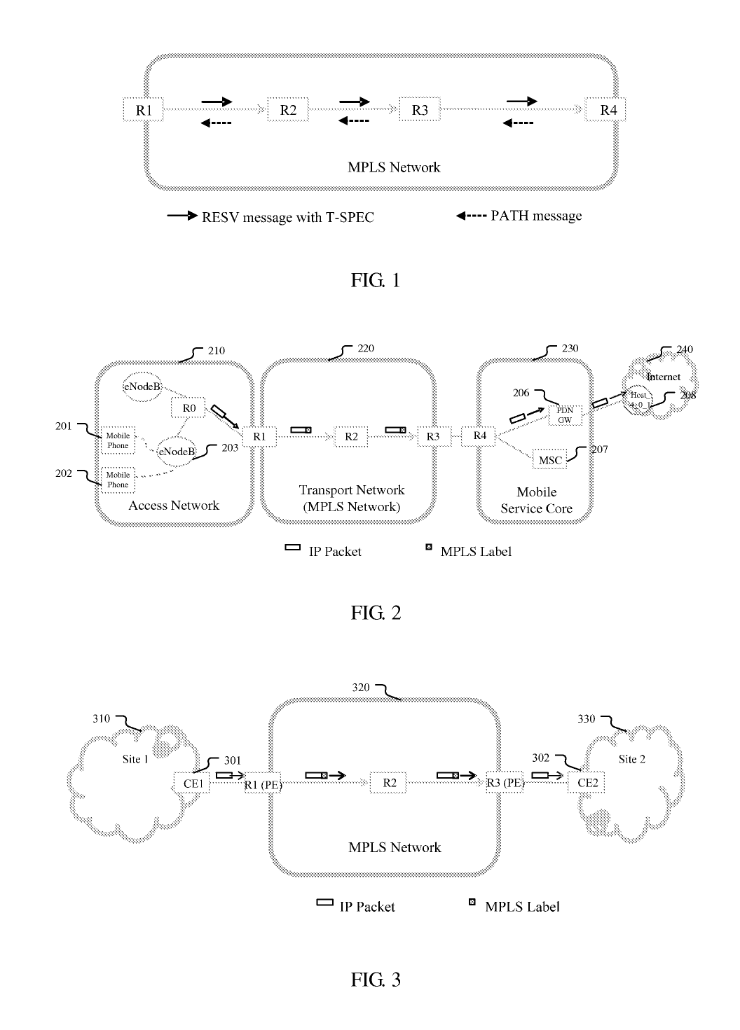

Like reference numbers and designations in the various drawings indicate like elements.

### DETAILED DESCRIPTION

Hereinafter, the principle and spirit of the present invention will be described with reference to the illustrative embodiments. It should be understood, all these embodiments are given merely for the skilled in the art to better understand and further practice the present invention, but not for limiting the scope of the present invention. For example, features illustrated or described as part of one embodiment may be used with another embodiment to yield still a further embodiment. In the interest of clarity, not all features of an actual implementation are described in this specification.

FIG. 2 illustrates an example scenario where embodiments of the present invention may be applied. In the shown scenario, the MPLS network 220 is used as the transport network for mobile backhaul. Mobile backhaul networks are required to support services that are delay and loss sensitive.

As shown in FIG. 2, the MPLS network 220 is connected between the access network 210 and the mobile service core network 230. Mobile phones 201, 202 may access the base station (BS) or evolved Node B (eNB) 203 via mobile telecommunication air interfaces. The eNB 203 transmits traffic flow received from the mobile phones 201, 202 to an access node (e.g., R0) provided with MPLS functions. The access node R0 may perform encapsulation of the traffic flow over MPLS. Then, the access node R0 transfers the encapsulated traffic flow to an edge node (e.g., an ingress node R1) of the MPLS network.

When an unlabeled packet enters the ingress node R1 and needs to be passed on to an MPLS tunnel, the router R1 first determines the forwarding equivalence class (FEC) the packet should be in, and then pushes one or more labels in the packet's newly created MPLS header. The packet is then passed on to the next hop router (e.g., a transit node R2) for this LSP.

When a labeled packet is received by an MPLS router (e.g., the transit node R2), the topmost label is examined. Based on the contents of the label a swap, push (impose) or pop (dispose) operation can be performed on the packet's label stack. Routers can have prebuilt lookup tables that tell them which kind of operation to do based on the topmost label of the incoming packet so they can process the packet very quickly.

At the egress node (e.g., R3), when the last label has been popped, only the payload remains. This can be an IP packet, or any of a number of other kinds of payload packet. The egress node R3 must therefore have routing information for the packet's payload.

Based on the routing information, the packet is transferred from the router R3 to a node R4 of the mobile service core network 230, for example a mobile aggregation site gateway (MASG). At the node R4, the packet is distributed based on its destination. For example, as shown in FIG. 2, the packet is distributed to a public data network gateway (PDN GW) 206, and then to a host (e.g., an application server) within the internet network 240. The node R4 may also be connected with other network elements, e.g., a mobile service center (MSC) 207.

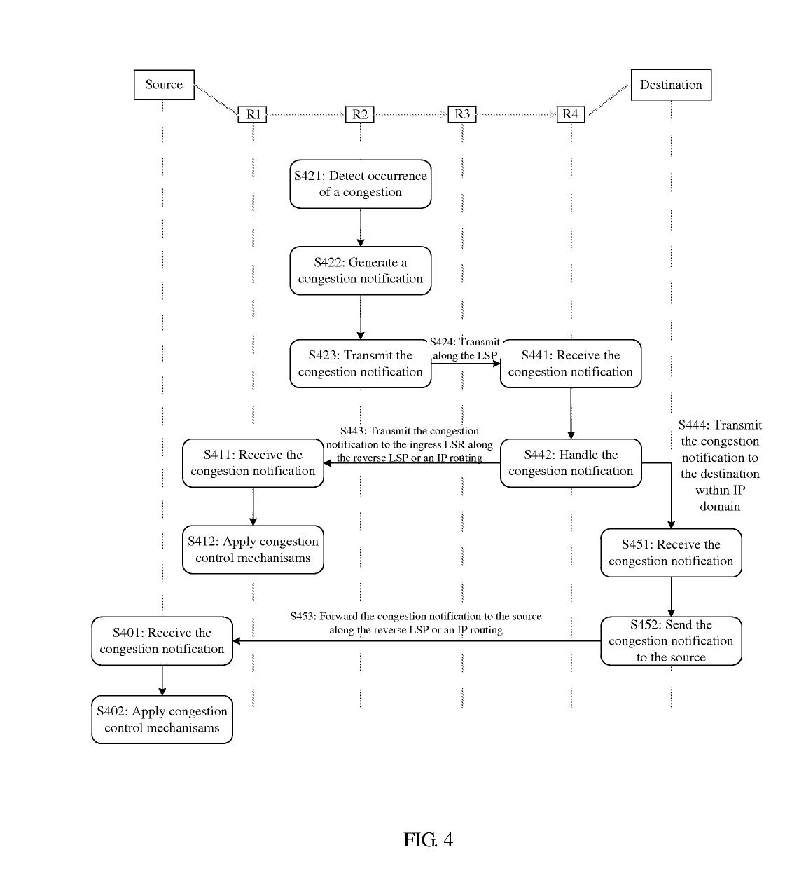

FIG. 3 illustrates another example scenario where embodiments of the present invention may be applied. In the shown scenario, the MPLS network 320 is employed to implement a virtual private network (VPN) to transfer traffic flow between two sites 310 and 330.

An MPLS-based virtual private network (VPN) is mainly consisted of three parts, Customer Edge (CE), Provider Edge (PE), and Provider (P).

A CE (e.g., CE1 301 and CE2 302) connects with the service provider network (e.g., the networks 310 and 330) directly, and it cannot perceive the existence of the VPN.

Label edge routers (LERs) that function as ingress and/or egress routers to the VPN are often called PE (Provider Edge) routers, for example the routers R1 and R3 as shown. A PE (e.g., R1) connects with a CE (e.g., CE1 301) directly and is responsible for VPN traffic access.

Devices that function only as transit routers are similarly called P (Provider) routers, for example the router R2 as shown. A P router is responsible for forwarding data quickly and does not connect with a CE directly.

In the whole MPLS VPN, the devices P and PE should support the basic functions of MPLS, while the devices CE need not to support MPLS.

The skilled in the art should appreciate that, FIGS. 2-3 merely illustrate some examples of the MPLS deployments, and other scenarios may also be possible.

As mentioned above, embodiments of the present invention have provided a congestion signaling mechanism in MPLS networks. In the following description, the proposed mechanism will be detailed with respect to exemplary embodiments illustrated in the drawings.

FIG. 4 illustrates an exemplary signal flow according to embodiments of the present invention.

In the process shown in FIG. 4, it is assumed that a label switched path (LSP) has been established between the ingress node R1 and the egress node R4. As shown, the LSP begins from the ingress node R1, via a transit node R2 and a transit node R3, and ends at the egress node R4. All these MPLS nodes may be routers or other devices which may function as routers. FIG. 4 also exemplarily shows the source node and the destination node of packets transmission within an IP network. The skilled in the art should appreciate that, the use of “source” and “destination” merely intends to indicate the transmission direction of the packets, which may be replaced with upstream host and downstream host. In this regard, the source node and the destination node may be any devices than the MPLS routers.

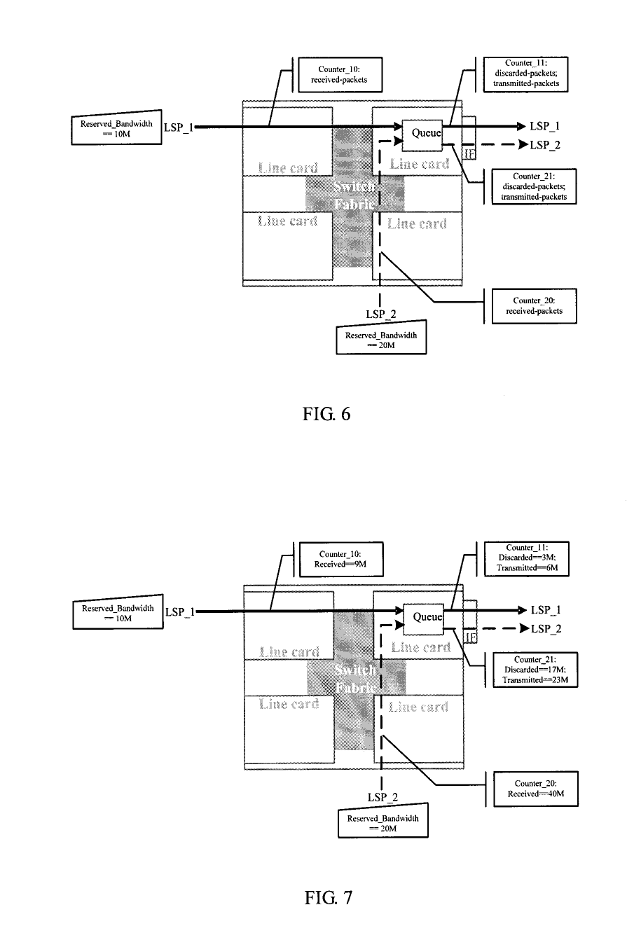

The signal flow may begin at step S421, where occurrence of a congestion is detected at the transit node R2 on the LSP. The detection of congestion may be implemented by various techniques, for example by monitoring discarded packets during a predefined period of time, which will be described in detail with reference to FIGS. 6-7 in the blow.

The skilled in the art could appreciate that, although R2 is illustrated to detect the occurrence of the congestion, other routers (e.g., R1, R3, and R4) on the LSP may also be provided with such function.

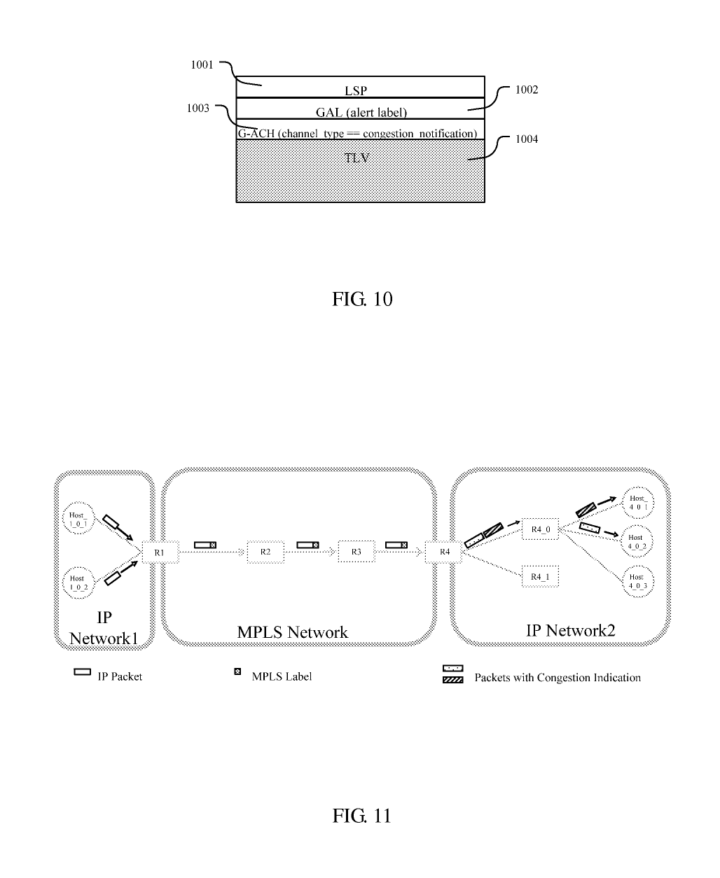

In response to the congestion occurring during transmission of packets, at the step S422, R2 generates a congestion notification. The congestion notification may comprise a field indicating itself as a congestion notification, and a field of information about discarded packets under the congestion. The structure of a message for congestion notification will be described later with reference FIG. 10.

Once a congestion notification is generated, at the step S423, R2 transmits the congestion notification to the egress node R4 on the LSP.

In some embodiments, the congestion notification is transmitted along the LSP (step S424). That is, the congestion notification is first passed to the transit node R3, and then to the egress node R4. Preferably, the congestion notification is transparent to downstream transit nodes on the LSP, such that there is no requirement for the downstream transit nodes to process the congestion notification. In this way, an in-band signaling mechanism has been provided for congestion notification for MPLS networks. Since the LSP has been established, such in-band signaling mechanism can be implemented by simply extending those existing definitions and deployments in the MPLS network and thus has provided backward compatibility.

Upon receiving the congestion notification from an upstream MPLS node (e.g., R3) at the step S441, the egress node R4 can handle the congestion notification at the step S442.

Usually, the egress node R4 performs a pop operation to remove the label from the packet of the congestion notification. An inner label below is then revealed. When a label indicating itself as a congestion notification is revealed, the egress node R4 can send this congestion notification to involved nodes, for example, the ingress node R1, the destination node of the packets, etc.

Normally, a LSP has a corresponding reverse LSP. The ingress node of the forward LSP is generally the egress node of the reverse LSP, and vice versa. However, the transit nodes of the LSP are not always the transit nodes of the reverse LSP. The transit nodes of the LSP do not know the reverse LSP, and only the egress node of the LSP, which is the ingress node of the reverse LSP, knows the reverse LSP.

In one embodiment, at the step S443, the egress node R4 transmits the congestion notification to the ingress node (e.g., R1) of the LSP. The transmitting may be performed along a corresponding reverse LSP of the LSP, i.e., in an in-band way. Optionally, the transmitting may be performed via an IP routing.

Having received the congestion notification at the step S411, the ingress node R1 of the LSP can apply congestion control mechanism at the step S412, in order to alleviate the congestion.

For example, the following actions may be taken to alleviate the congestion. The ingress node R1 can limit the transmission rate of the packets over this LSP. Dropping/discarding packets at the ingress node R1 could alleviate the congestion. The ingress node R1 can also migrate the traffic to another LSP with a bigger bandwidth. The skilled in the art could appreciate that, other congestion control mechanisms known in the art may be applied, and the present invention has no limitation in this regard.

In some embodiments, the ingress node R1 can activate a timer for the LSP under congestion. Once the timer expires, the ingress node R1 can stop using those congestion control mechanisms.

Thus, the congestion notification in the MPLS network can be accomplished. The proposed congestion notification can be extended into the IP networks, more exactly, to the IP hosts who produce and consume the traffic, i.e., the source node and the destination node.

Specifically, return to the egress node R4. Once the congestion notification arrives at the egress node R4, R4 can propagate the congestion notification into the IP domains. At the step S444, the egress node R4 can transmit the congestion notification to the destination node of the packets within an IP network. The transmitting may be performed via an IP routing by explicit congestion notification (ECN) signaling.

Upon receiving the congestion notification at the step S451, the destination node can send the congestion notification back to the source node at the step S452. More particularly, at the step S453, the destination node forwards the congestion notification to the source node via an IP routing to the egress node, then via the corresponding reverse LSP from the egress node to the ingress node, and finally via an IP routing from the ingress node to the source node. Optionally, the forwarding may be performed via an IP routing directly from the destination node to the source node.

Then, after receiving the congestion notification at the step S401, the source node can apply congestion control mechanisms at the step S402. For example, the source node can slow down the transmission rate of that traffic. Other congestion control mechanisms may also be applied.

Although embodiment of the present invention have been described with respect to FIG. 4, the skilled person in the art could appreciate that many modification may be made in light of the disclosure herein. For example, upon receive the congestion notification, the ingress node R1 can send it to the source node directly, without forwarding from the destination node.

As mentioned previous, any router in the MPLS network may be provided with the congestion notification function as proposed in the present invention.

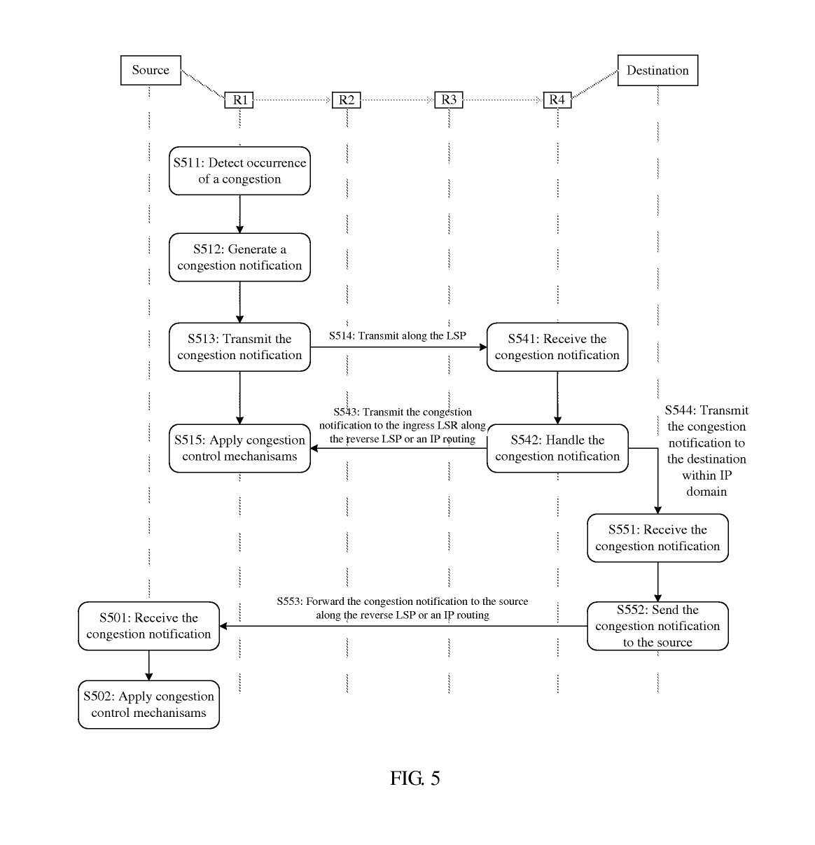

FIG. 5 illustrates another exemplary signal flow according to embodiments of the present invention. In the example shown in FIG. 5, all assumptions are the same with those of the example shown in FIG. 4, except that a congestion occurs in the ingress node R1.

As shown in FIG. 5, the signal flow may begin at step S511, where occurrence of a congestion during transmission of packets is detected at the ingress node R1 on the LSP. In response to the congestion occurring, at the step S512, R1 generates a congestion notification.

Then, at the step S513, R1 transmits the congestion notification to the egress node R4 on the LSP. Similarly, in some embodiments, the congestion notification is transmitted along the LSP (step S514). That is, the congestion notification is first passed to the transit node R2, via the transit node R3, and then to the egress node R4.

Different from the embodiment shown in FIG. 4, after detecting the congestion, at the step S515, the ingress node R1 can apply congestion control mechanism immediately, without waiting the congestion notification sent back from the egress node R4.

In the egress node R4, upon receiving the congestion notification from an upstream MPLS node (e.g., R3) at the step S541, it can handle the congestion notification at the step S542.

In some embodiments, when handling the congestion notification, R4 can transmit it to the destination node (i.e., the downstream host) and also send the congestion notification back to the ingress node as done in the example in FIG. 4.

Other operations are similar to those in the embodiment shown in FIG. 4, and thus the description thereof is omitted here.

FIGS. 6-7 illustrate an example mechanism for recognizing the LSP under congestion, i.e., the mechanism for detecting a congestion on a LSP.

FIGS. 6 and 7 briefly illustrate the MPLS quality of service (QoS) mechanisms on a label switched router (LSR), e.g., R1-R4. The LSR may comprise a plurality of line cards, including ingress line cards and egress line cards. There is a switch fabric to switch between the ingress line cards and the egress line cards. Here, we omit the rate limiting on the ingress line card.

FIGS. 6 and 7 have shown two LSPs on a LSR. LSP_1 has a committed information rate (CIR) of 10 Mb/s, and LSP_2 has a CIR of 20 Mb/s. The reserved bandwidth for LSP_1 is 10 Mb/s, and the reserved bandwidth for LSP_2 is 20 Mb/s.

The ingress line card of LSP_1 has a Counter_10 to count the received packets, and the ingress line card of LSP_2 has a Counter_20 to count the received packets. LSP_1 and LSP_2 have a same egress line card, and thus a queue is use to arranged the transmission of the packets of LSP_1 and LSP_2. In the egress line card, there is a Counter 11 to count the dropped packets and the transmitted packets for LSP_1, and a Counter_21 to count the dropped packets and the transmitted packets for LSP_2.

LSP_2 can be configured to carry some detour traffic to protect the adjacent node/link. In case of MPLS protection, i.e., Fast ReRouter (FRR), LSP_2 will carry more traffic than reserved bandwidth. As illustrated in FIG. 7, LSP_2 carries the traffic of 40 Mb/s.

Since the outsegment port, IF (interface) shown in FIG. 7, has a capacity of 30 Mb/s, some traffic carried by LSP_1 and/or LSP_2 will be discarded/dropped.

As shown in FIG. 7, LSP_1 sends 6 Mb/s traffic at IF and drops 3 Mb/s; while LSP_2 sends 23 Mb/s traffic at IF and drops 17 Mb/s. Packet loss on both LSP_1 and LSP_2 may trigger the congestion notification mechanism as proposed. Thus, the congestion may be detected and the LSP under the congestion may be recognized.

For the example shown in FIG. 7, for LSP_1, the received traffic, about 9 Mb/s, is smaller than the CIR, 10 Mb/s; for LSP_2, the received traffic, about 40 Mb/s, is far bigger than the CIR, 20 Mb/s. It is easy for the congestion notification mechanism to recognize that LSP_2 is the LSP under congestion, while LSP_1 is not.

The skilled in the art could appreciate that, other congestion detection mechanism may be employed, and the present invention has no limitation in this point.

After the recognition of the LSP under congestion, the LSR will generate a congestion notification and run the congestion notification transmission procedure.

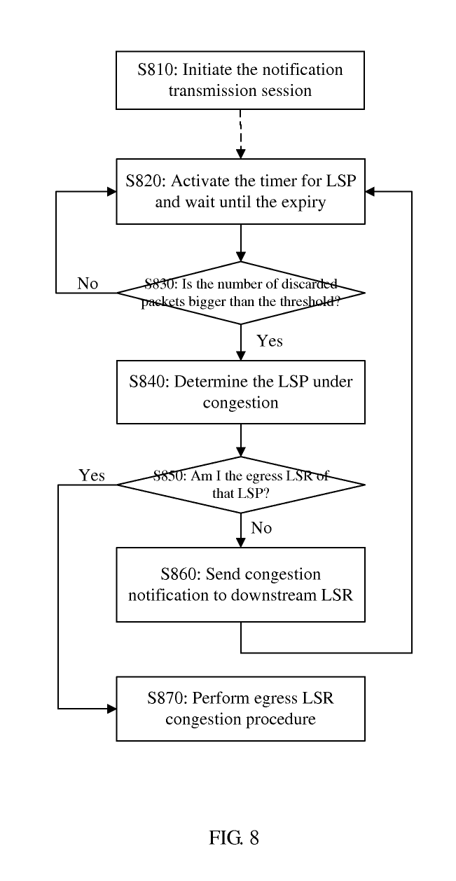

FIG. 8 illustrates an exemplary flowchart of a method for congestion notification transmission procedure according to embodiments of the present invention.

The method may begin with the step S810, where the congestion notification transmission session is initiated. Then, at the step S820, the LSR will activate a timer for the LSP under congestion and wait until the timer expires. Normally, a congestion only continues for some time. Thus, after a period time set by the timer, the congestion control mechanism can be cancelled, and normal operation can be proceeded with.

Then, at the step S830, the LSR determines whether the number of discarded packets is bigger than a predetermined threshold. If yes, the method goes to the step S840, where the LSR can determine that the LSP is under congestion. If no, the method goes back to the step S820.

Once the LSR under congestion is determined, at the step S850, the LSR will determine whether it is the egress LSR of that LSP under congestion. If yes, the method goes to the step S870, where the egress LSR performs egress LSR congestion procedure. If no, the method goes to the step S860, where the LSR send the congestion notification to its downstream LSR. Then, the method will go back to the step S820 and monitor the occurrence of a congestion.

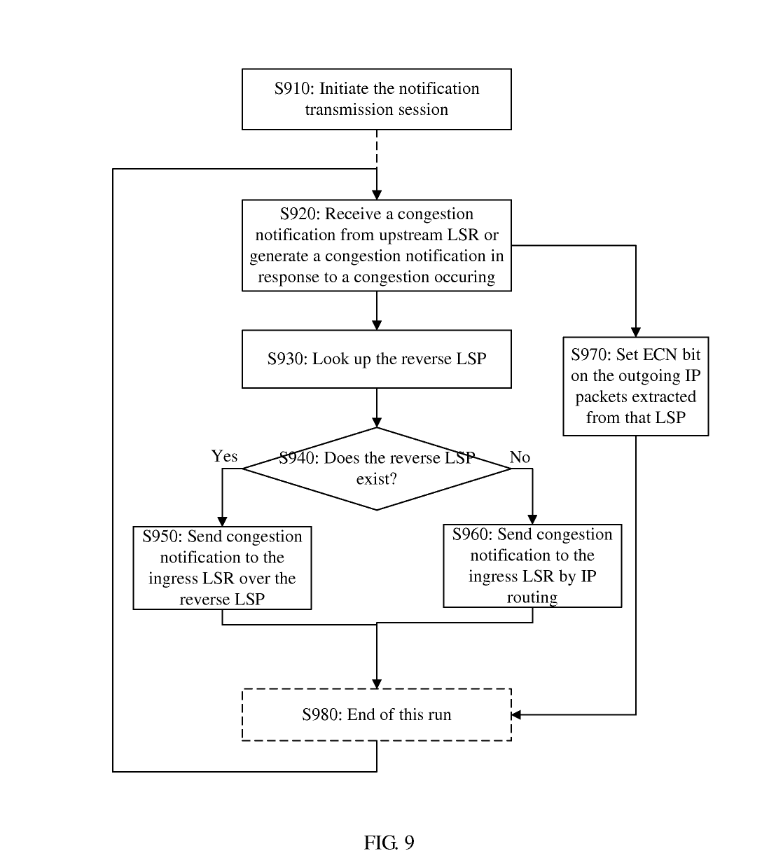

FIG. 9 illustrates an exemplary flowchart of a method of congestion control procedure for an egress node according to embodiments of the present invention. Upon receiving a congestion notification from an upstream LSR, or determining a congestion by itself, the egress LSR will apply congestion control procedure for that LSP under congestion.

The method may begin with the step S910, where the congestion notification transmission session is initiated. At the step S920, the egress LSR receives a congestion notification from an upstream LSR, or it determines that the discarded packets are more than the predefined threshold and in turn generates a congestion notification in response to the congestion occurring.

Then, at the step S930, the egress LSR may look up a reverse LSP corresponding to the LSP under congestion.

At the step S940, the egress LSR determines whether the reverse LSP exists. If yes, the method goes to the step S950, where the egress LSR send the congestion notification back to the ingress LSR of the LSP over the reverse LSP. If no, the method goes to the step S960, where the egress LSR sends the congestion notification to the ingress LSR of the LSP by IP routing. Then, this run ends at the step S980.

Additionally, the egress LSR may further propagate the congestion notification to the IP domains. For example, at the step S970, the egress LSR can set ECN bit on the outgoing IP packets extracted from the LSP under congestion, so as to inform its downstream IP hosts.

FIG. 10 illustrates an exemplary congestion notification packet according to embodiments of the present invention. In some embodiments, the congestion notification packet may be encapsulated in a Generic Associated Channel (G-ACH) packet which following IETF RFC5586 (Request for Comments: 5586).

As shown in FIG. 10, the congestion notification packet may comprise a LSP label 1001, which enables the congestion notification packet to be transmitted within the MPLS network. The congestion notification packet may further comprise a G-ACH Label (GAL) 1002, which is used to inform an LSR (or LER) that a packet it receives on an LSP or Section belongs to an associated control channel, i.e., an alert label.

Following, the congestion notification packet comprises a G-ACH packet 1003, which includes a field indicating the channel type of message carried on the associated control channel. A new channel type should be allocated for the congestion notification.

In addition, the congestion notification packet may comprise a Type-Length-Value (TLV) field 1004. The TLV field comprises information about discarded packets on the LSP under congestion. The information about the discarded packets could be the truncated packets or partial packet header.

Thus, above have described various aspects of the present invention in conjunction with the illustrative figures. For more intuitive, FIGS. 11-13 illustrate the signal flow in combination with an example scenario according to embodiments of the present invention. In the example scenario, MPLS network is served as transport network between two IP networks.

FIG. 11 illustrates an exemplary signal flow for transmitting congestion notification to the downstream hosts according to embodiments of the present invention. Besides the transmission of the congestion notification packets to the ingress LSR of the LSP, the egress LSR also propagates the congestion signal to the downstream hosts.

As shown in FIG. 11, the senders (i.e., sources), Host_1_0_1 and Host_1_0_2, talk with their counterparts (i.e., destinations), Host_4_0_1 and Host_4_0_2. But the LSP is experiencing congestion, and the transit router R2 drops some packets carried over that LSP and sends out the congestion notification to the egress LSR, R4. After receiving the congestion notification, the egress LSR, R4, will mark the ECN bits in the header of the IP packets carried over that LSP, and forward those packets to a node within the IP network 2, R4_0. R4_0 forwards the packets to the receivers, Host_4_0_1 and Host_4_0_2.

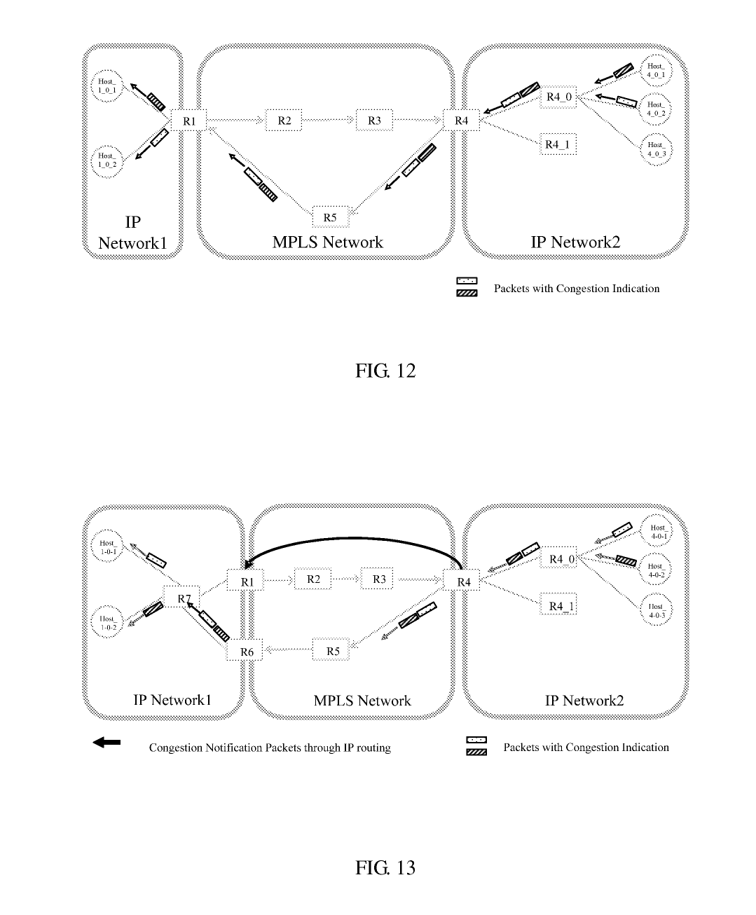

FIG. 12 illustrates an exemplary signal flow for transmitting congestion notification to upstream hosts according to embodiments of the present invention.

As shown in FIG. 12, the receivers, Host_4_0_1 and Host_4_0_2, insert the congestion indication into the packets to the senders residing in the IP network 1 by marking the Congestion Experienced bits in the Transport control protocol (TCP) acknowledge (ACK) packets. Then, the packets are transmitted to the counterpart peer in the IP network 1. The packets with congestion indication are carried over the MPLS network and IP network 1 to reach the senders, Host_1_0_1 and Host_1_0_2.

FIG. 13 illustrates an exemplary signal flow for transmitting congestion notification to upstream nodes according to embodiments of the present invention.

As shown in FIG. 13, there are two LSPs connecting IP network 1 with IP network 2. Once the transit router R2 detects the congestion, it will send in-band congestion notification to the egress LSR, R4. R4 finds that a corresponding reverse LSP does not reach the ingress LSR R1, and then it can send back the congestion notification packet to R1 by IP routing, as indicated by the black thick arrow in FIG. 13. R4 also marks the ECN bits in the header of the IP packets carried over that LSP and sends it to Host_4_0_1 and Host_4_0_2 within the IP network 2.

Host_4_0_1 and Host_4_0_2 send TCP ACK packets with congestion marking to R4. R4 delivers the packets over a LSP to R5. R5 sends the MPLS packets to R6. Finally, R6 sends them to Host_1_0_1 and Host_1_0_2. Upon receiving the packets, Host_1_0_1 and Host_1_0_2, the traffic generators, can slow down the transmission to reduce the congestion. Alternatively, Host_4_0_1 and Host_4_0_2 can send the TCP ACK packets via other paths than illustrated in FIG. 13, e.g., via IP routing directly.

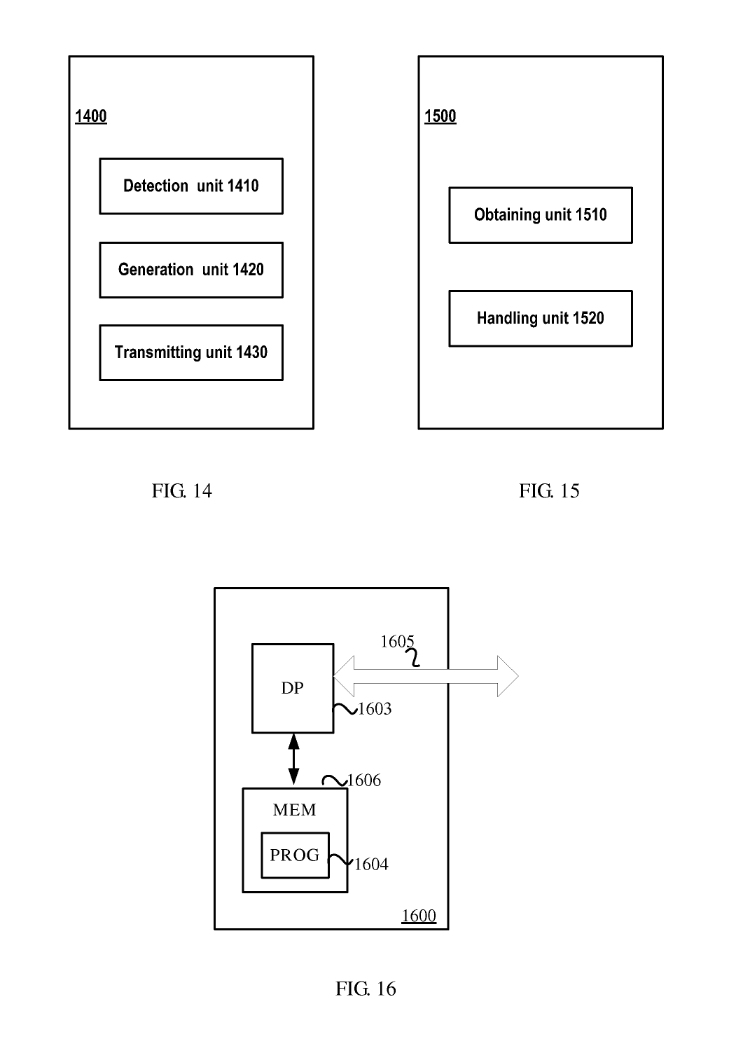

FIG. 14 is a schematic block diagram of an apparatus 1400 that may be configured to practice exemplary embodiments according to one aspect of the present invention.

As shown in FIG. 14, the apparatus 1400 may comprise a detection unit 1410, a generation unit 1420, and a transmitting unit 1430. The apparatus 1400 may be a MPLS router, especially a transit router within a MPLS network.

The detection unit 1410 may be configured to detect the occurrence of a congestion by monitoring amount of discarded packets during a predefined period of time.

The generation unit 1420 may be configured to generate a congestion notification in response to a congestion occurring during transmission of packets, e.g., detected by the detection unit 1410.

The transmitting unit 1430 may be configured to transmit the congestion notification to an egress node on the LSP under congestion. Preferably, the transmitting unit 1430 is configured to transmit the congestion notification along the LSP to the egress node. Further, the congestion notification is transparent to downstream transit nodes on the LSP.

It should be understood, the units 1410-1430 contained in the apparatus 1400 are configured for practicing exemplary embodiments of the present invention. Thus, the operations and features described above with respect to FIGS. 4-13 also apply to the apparatus 1400 and the units therein, and the detailed description thereof is omitted here.

FIG. 15 is a schematic block diagram of an apparatus 1500 that may be configured to practice exemplary embodiments according to another aspect of the present invention.

As shown in FIG. 15, the apparatus 1500 may comprise an obtainment unit 1510, and a handling unit 1520. The apparatus 1500 may be an egress node within a MPLS network.

The obtaining unit 1510 may be configured to obtain a congestion notification which occurs during transmission of packets. The congestion notification may be obtained by receiving the congestion notification from an upstream LSR within the MPLS network, or by generating the congestion notification in response to the congestion occurring in the apparatus 1500 itself.

The handling unit 1520 may be configured to handle the congestion notification. In some embodiments, the handling unit 1520 is configured to transmit the congestion notification to an ingress node of the LSP under congestion. Additionally or alternatively, the handling unit 1520 is configured to transmit the congestion notification to a destination node of the packets within an IP network, such that the congestion notification can be forwarded to a source node of the packets within an IP network and/or to the ingress node on the LSP under congestion.

It should be understood, the units 1510-1520 contained in the apparatus 1400 are configured for practicing exemplary embodiments of the present invention. Thus, the operations and features described above with respect to FIGS. 4-13 also apply to the apparatus 1500 and the units therein, and the detailed description thereof is omitted here.

FIG. 16 illustrates a simplified block diagram of an entity 1600 that is suitable for use in practicing exemplary embodiments of the present invention. The entity may be a router within a MPLS network, such as an ingress router, a transit router or an ingress router.

As shown in FIG. 16, the entity 1600 includes a data processor (DP) 1603, a memory (MEM) 1606 coupled to the DP 1603, and a communication interface 1605 coupled to the DP 1603. The MEM 1606 stores a program (PROG) 1604. The communication interface 1605 is for communications with other entities, e.g., other MPLS routers, access node within IP domains, etc.

The PROG 1604 is assumed to include program instructions that, when executed by the associated DP 1603, enable the entity 1600 to operate in accordance with the exemplary embodiments of this invention, as discussed herein with the methods shown in FIGS. 8-9. For example, the functions of the detection unit 1410, generation unit 1420 of the apparatus 1400 may be implemented as the PROG 1604 stored in the MEM 1606. The transmitting unit 1430 may be embodied as the communication interface 1605. When the PROG 1604 is executed by the DP 1603, it enables the apparatus 1400 to operate in accordance with the exemplary embodiments of the present invention. As another example, the functions of the obtaining unit 1510 and the handling unit 1520 of the apparatus 1500 may be embodied as the PROG 1604 stored in the MEM 1606 and the communication interface 1605. Similarly, when the PROG 1604 is executed by the DP 1603, it enables the apparatus 1500 to operate in accordance with the exemplary embodiments of the present invention.

The embodiments of the present invention may be implemented by computer software executable by the DP 1603 of the entity 1600, or by hardware, or by a combination of software and hardware.

The MEM 1606 may be of any type suitable to the local technical environment and may be implemented using any suitable data storage technology, such as semiconductor based memory devices, magnetic memory devices and systems, optical memory devices and systems, fixed memory and removable memory, as non-limiting examples. While only one MEM is shown in the entity 1600, there may be several physically distinct memory units in the entity 1600. The DP 1603 may be of any type suitable to the local technical environment, and may include one or more of general purpose computers, special purpose computers, microprocessors, digital signal processors (DSPs) and processors based on multicore processor architecture, as non limiting examples. The entity 1600 may have multiple processors, such as for example an application specific integrated circuit chip that is slaved in time to a clock which synchronizes the main processor.

Exemplary embodiments of the present invention have been described above with reference to block diagrams and flowchart illustrations of methods, apparatuses (i.e., systems). It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

The foregoing computer program instructions can be, for example, sub-routines and/or functions. A computer program product in one embodiment of the invention comprises at least one computer readable storage medium, on which the foregoing computer program instructions are stored. The computer readable storage medium can be, for example, an optical compact disk or an electronic memory device like a RAM (random access memory) or a ROM (read only memory).

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It should also be noted that the above described embodiments are given for describing rather than limiting the invention, and it is to be understood that modifications and variations may be resorted to without departing from the spirit and scope of the invention as those skilled in the art readily understand. Such modifications and variations are considered to be within the scope of the invention and the appended claims. The protection scope of the invention is defined by the accompanying claims. In addition, any of the reference numerals in the claims should not be interpreted as a limitation to the claims. Use of the verb “comprise” and its conjugations does not exclude the presence of elements or steps other than those stated in a claim. The indefinite article “a” or “an” preceding an element or step does not exclude the presence of a plurality of such elements or steps.

1. A method performed by a transit node on a label switched path (LSP) within a multi-protocol label switching (MPLS) network, comprising:
generating a congestion notification in response to a congestion occurring during transmission of packets; and
transmitting the congestion notification to an egress node on the LSP.

2. The method of claim 1, wherein transmitting the congestion notification comprises:
transmitting said congestion notification along said LSP to the egress node.

3. The method of claim 1, wherein said congestion notification is transparent to downstream transit nodes on said LSP.

4. The method of claim 1, wherein said congestion notification comprises a field indicating itself as a congestion notification, and a field of information about discarded packets under the congestion.

5. A method performed by an egress node on a label switched path (LSP) within a multi-protocol label switching (MPLS) network, comprising:
obtaining a congestion notification, wherein the congestion occurs during transmission of packets; and
handling the congestion notification.

6. The method of claim 5, wherein handling the congestion notification comprises at least one of the following:
transmitting said congestion notification to an ingress node on said LSP; and
transmitting said congestion notification to a destination node of the packets within an IP network, such that the congestion notification can be forwarded to a source node of the packets within another IP network.

7. The method of claim 6, wherein
said transmitting to the ingress node comprises transmitting over a corresponding reverse LSP; and
said forwarding to the source node comprises transmitting via an IP routing from the destination node to the egress node, via a corresponding reverse LSP from the egress node to the ingress node, and via an IP routing from the ingress node to the source node.

8. The method of claim 5, wherein obtaining a congestion notification comprises at least one of the following:
receiving the congestion notification from an upstream node on said LSP; and
generating the congestion notification in response to the congestion occurring.

9. A transit node configured for operation on a label switched path (LSP) within a multi-protocol label switching (MPLS) network, said transit node comprising:
a communication interface configured for communicating within one or more other nodes on the LSP; and
a processing circuit operatively associated with the communication interface and configured to:
generate a congestion notification in response to a congestion occurring during transmission of packets; and
transmit the congestion notification to an egress node on the LSP.

10. The transit node of claim 9, wherein the processing circuit is configured to transmit said congestion notification along said LSP to the egress node.

11. The transit node of claim 9, wherein said congestion notification is transparent to downstream transit nodes on said LSP.

12. The transit node of claim 9, wherein said congestion notification comprises a field indicating itself as a congestion notification, and a field of information about discarded packets under the congestion.

13. The transit node of claim 9, wherein the processing circuit is further configured to detect the occurrence of the congestion by monitoring amount of discarded packets during a predefined period of time.

14. An egress node configured for operation on a label switched path (LSP) within a multi-protocol label switching (MPLS) network, said egress node comprising:
a communication interface configured to communicate with one or more other nodes on the LSP; and
a processing circuit operatively associated with the communication interface and configured to:
obtain a congestion notification, wherein the congestion occurs during transmission of packets; and
handle the congestion notification.

15. The egress node of claim 14, wherein the processing circuit is configured to perform at least one of the following:
transmit said congestion notification to an ingress node on said LSP; and
transmit said congestion notification to a destination node of the packets within an IP network, such that the congestion notification can be forwarded to a source node of the packets within another IP network.

16. The egress node of claim 15, wherein the processing circuit is configured to transmit said congestion notification to the ingress node over a corresponding reverse LSP.

17. (canceled)

18. A non-transitory computer-readable medium storing a computer program comprising program instructions that, when executed by a processing circuit of a transit node configured for operation on a label switched path (LSP) within a multi-protocol label switching (MPLS) network, configures the transit node to:
generate a congestion notification in response to a congestion occurring during transmission of packets; and
transmit the congestion notification to an egress node on the LSP.
